(19) United States
(12) Patent Application Publication
(10) Pub. No.: US 2025/0051154 A1
(43) Pub. Date: Feb. 13, 2025

(54) MODULAR STRUCTURES FOR MIXING DEVICES

(71) Applicant: 3M INNOVATIVE PROPERTIES COMPANY, St.Paul, MN (US)

(72) Inventors: Gustavo H. Castro, Woodbury, MN (US); Dong Fu, Woodbury, MN (US); Kent E. Lageson, Prior Lake, MN (US)

(21) Appl. No.: 18/721,122

(22) PCT Filed: Dec. 29, 2022
(86) PCT No.: PCT/IB2022/062886

§ 371 Date: Jun. 17, 2024

Related U.S. Application Data
(60) Provisional application No. 63/266,187, filed on Dec. 30, 2021.

(51) Int. Cl. B67D 3/00; B05C 11/10

(52) U.S. Cl. CPC B67D 3/0012; B05C 11/1036

(57) ABSTRACT

Adapter (130, 430, 500, 600, 700)s for mixing devices are provided. The adapter (130, 430, 500, 600, 700) connects to a fluid delivery component (110, 310, 410) at the first end (132, 332, 432, 532, 612A, 612B, 632, 732) to receive multiple fluid feeding materials and connects to a mixer tip (120, 320, 420, 820) at the second end (134, 334, 434, 634, 734) to deliver the feeding materials.

### BACKGROUND

Mixing devices or tools such as mixers or blenders for adhesives and sealants are widely used. For example, mixers are commercially available for two-part adhesives. A static or dynamic mixer is a precision engineered device for the continuous mixing of fluid materials, without or with moving components. Normally the fluids to be mixed are liquid, but mixers can also be used to mix gas streams, disperse gas into liquid or blend immiscible liquids. The energy needed for mixing comes from a loss in pressure as fluids flow through the mixer. One design of mixer is a plate-type mixer and another common device type consists of mixer elements (e.g., a rotating screw) contained in a cylindrical (tube) or squared housing.

### SUMMARY

There is a desire to optimize mixing tools to improve the mixing performance and quality. The present disclosure provides mixing devices including an adapter to adapt various mixing tips to delivery units.

In one aspect, the present disclosure describes an adapter for a mixing device. The adapter includes a conduit having a first end and a second end, a plurality of inlets disposed at the first end of the conduit configured to receive a plurality of fluid feeding materials, and an outlet disposed at a second end of the conduit fluidly connected to the plurality of inlets. The conduit, the plurality of inlets, and the outlet are configured such that the plurality of fluid feeding materials are not substantially mixed with each other when exiting from the outlet.

In another aspect, the present disclosure describes a mixing device. The mixing device or mixer includes a fluid delivery component configured to provide a plurality of fluid feeding materials, a mixer tip configured to mix the plurality of fluid feeding materials, and an adapter described herein. The conduit of the adapter is connected to the fluid delivery component at the first end and connected to the mixer tip at the second end.

In another aspect, the present disclosure describes a method including delivering a plurality of fluid feeding materials from a fluid delivery component to a plurality of inlets of an adapter, and transferring the plurality of fluid feeding materials from the plurality of inlets to an outlet of the adapter such that the plurality of fluid feeding materials are not substantially mixed with each other when exiting from the outlet.

Various unexpected results and advantages are obtained in exemplary embodiments of the disclosure. One such advantage of exemplary embodiments of the present disclosure is that modular structures are provided to adapt to a delivery unit which allows a user to change a static delivery system to a rotating mixing system. The fluid exiting the outlet of an adapter feeds into a rotating unit and decouples the fluid flow rate from the delivery unit to the rotating unit. This allows to increase the speed of mixing, and allows the use of different mixing tips to enhance the mixing effect. In addition, the adapters provide room for a premix chamber and are exchangeable and disposable.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is an exploded view of a mixing device, according to one embodiment.

FIG. 2 is a cross-sectional view of an adapter, according to one embodiment.

FIG. 3A is a side perspective view of a mixing device, according to one embodiment.

FIG. 3B is an exploded view of the mixing device of FIG. 3A.

FIG. 4A is a side perspective view of a mixing device, according to one embodiment.

FIG. 4B is an exploded view of the mixing device of FIG. 4A.

FIG. 5A is a side perspective view of an adapter, according to one embodiment.

FIG. 5B is an illustration of fluids A and B in the adapter of FIG. 5A.

FIG. 5C is a cross-sectional view of a simulated fluid concentration for fluids A and B in the adapter of FIG. 5A.

FIG. 6A is a side perspective view of an adapter, according to one embodiment.

FIG. 6B is an illustration of fluids A and B in the adapter of FIG. 6A.

FIG. 6C is a cross-sectional view of a simulated fluid concentration for fluids A and B in the adapter of FIG. 6A.

FIG. 7A is a side perspective view of an adapter, according to one embodiment.

FIG. 7B is a cross-sectional view of a simulated fluid concentration for fluids A and B in the adapter of FIG. 7A.

FIG. 8A is a cross-sectional view of a mixer tip in an open state, according to one embodiment.

FIG. 8B is a cross-sectional view of the mixer tip of FIG. 8A in a closed state, according to one embodiment.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

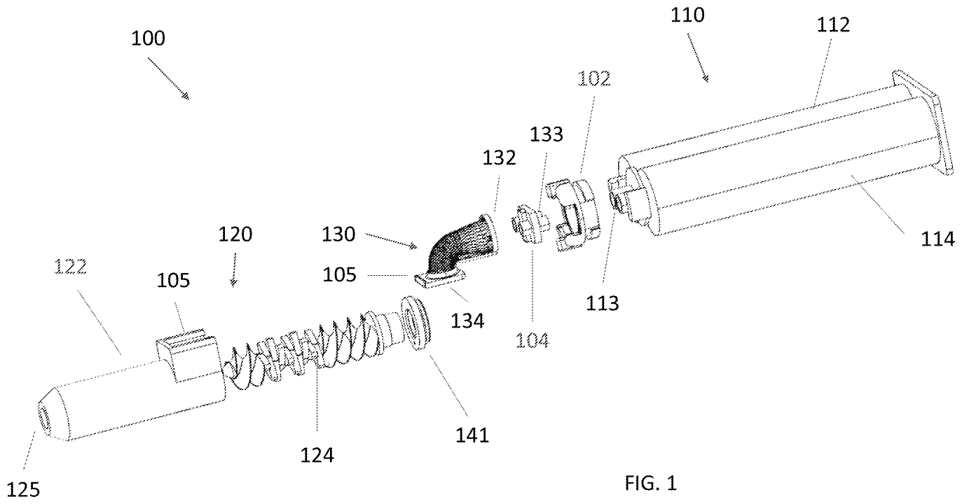

FIG. 1 is an exploded view of a mixing device 100, according to one embodiment. The mixing device or mixer 100 includes a fluid delivery component 110 configured to provide multiple fluid feeding materials, and a mixer tip 120 configured to mix the multiple fluid feeding materials inside a mixing chamber 122 thereof to form a mixture. An adaptor 130 connects to the fluid delivery component 110 at the first end 132 and connects to the mixer tip 120 at the second end 134.

The fluid delivery component 110 includes a first cartridge 112 and a second cartridge 114 to provide a first feeding material and a second feeding material, respectively. The first and second feeding materials may be different types of fluids having a ratio of viscosity, for example, greater than 2:1, greater than 5:1, greater than 10:1, or greater than 100:1. In some examples, the ratio of viscosity may be as high as from 10:1 or 500:1. The first and second cartridges are configured to deliver the first and second fluid materials in a flow rate in a range, for example, from 10 mL/min to 1000 mL/min. Exemplary feeding materials may include any type of two-part adhesive, sealants, fluids with fillers, adding color to a fluid, reactive fluids, etc. It is to be understood that three or more fluid materials can be provided by the fluid delivery component 110. In some embodiments, additional delivery components may be available to deliver feeding materials in a form other than liquid (e.g., particles) into the adapter 130.

The fluid delivery component 110 delivers the multiple feeding materials to the adapter 130 via the respective inlets/outlets. The adapter 130 has its first end 132 connected to the outlets 113 of the fluid delivery component 110 via a mounting mechanism. In the depicted embodiment, a collar lock 102 is used as the mounting mechanism, which includes a rotating or sliding mechanism. Collar lock inserts 104 are received by the collar lock 102 at the first end 132 of the adapter 130, including multiple fluid channels respectively connected to the outlets 113, serving as the inlets of the adapter 130. It is to be understood that the adapter 130 and the fluid delivery component 110 can be connected by any other suitable mounting mechanism.

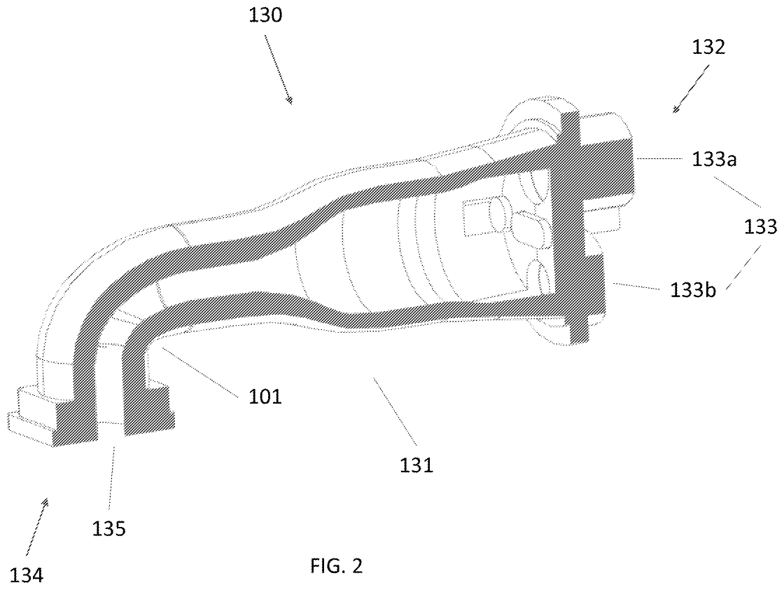

Referring to FIG. 2, the adapter 130 includes a conduit 131 extending between the first end 132 and the second end 134 thereof. Multiple inlets 133 (133a and 133b in this embodiment) are disposed at the first end 132 of the conduit 131, configured to receive multiple fluid feeding materials, respectively. An outlet 135 is disposed at the second end 134 of the conduit 131 and fluidly connected to the inlets 133. The conduit 131, the inlets 133, and the outlet 135 are configured such that the multiple fluid feeding materials are not substantially mixed with each other when exiting from the outlet 135.

In the embodiment depicted in FIG. 2, the conduit 131 of the adapter 130 has a tapered shape which tapers away from the first end 132 to the second end 134. Tapering the shape of the conduit 131 may force the liquid materials to rapidly fuse into each other and create a more homogeneous solution of materials before exiting the outlet 135 into a mixing chamber. In the case of two miscible fluids where diffusion can contribute to mixing, the tapered shape of the adapter can improve the diffusion efficiency. Also, the taper may increase the shear rate to reduce the effective viscosity of the solution to enable more mixing.

The conduit 131 has an L shape portion at the second end 134 with a turning point 101 adjacent to the outlet 135. The L shape portion may form an angle at the turning point 101 in a range, for example, 30° to 150°. The L shape helps to adapt and lock the adapter to a downstream mixing chamber.

Referring again to FIG. 1, the adapter 130 is connected, via a mounting mechanism 105, to the mixer tip 120 at its second end 134. In the depicted embodiment, the mounting mechanism 105 includes a sliding mechanism with a press fit or collar clip to add or remove the mixer tip 120. It is to be understood that the adapter 130 and the mixer tip 120 can be connected by any suitable mounting mechanism.

The mixer tip 120 is configured to receive the multiple feeding materials from the outlet at the second end 134 of the adapter 130, substantially mix the multiple feeding materials inside a mixing chamber 122 to form a mixture, and deliver the mixture via an outlet 125. A mixing element 124 is received in the mixing chamber 122. The mixing element 124 may have a shaft coupled with a motor to rotate the mixing element 124. In some examples, a mixing element can be a combination of Archimedes screw elements which push the material forward or backward depending on the element orientation, coupled with elements that provide separation and high-shear generation which provides more mixing. A mechanical seal 141 is provided to seal one end of the mixer tip 120 which is opposite the outlet 125.

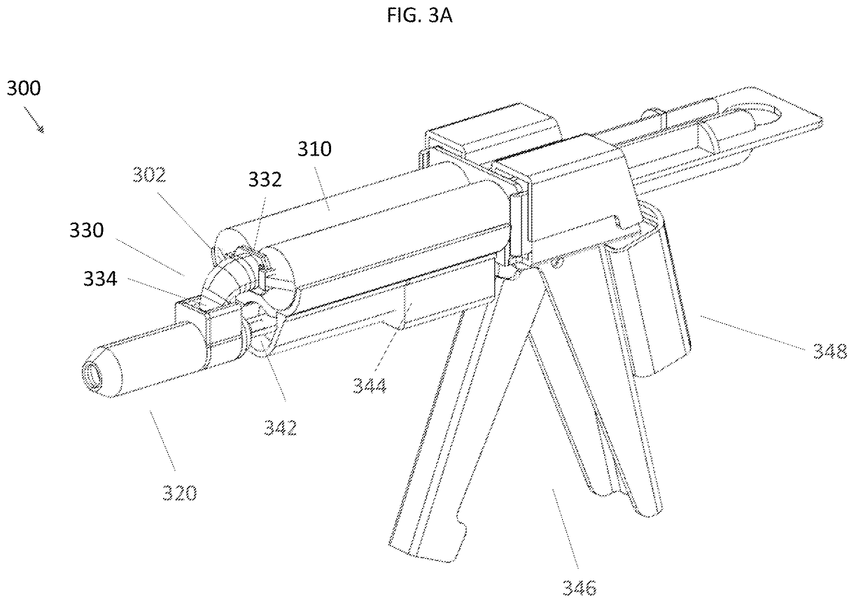

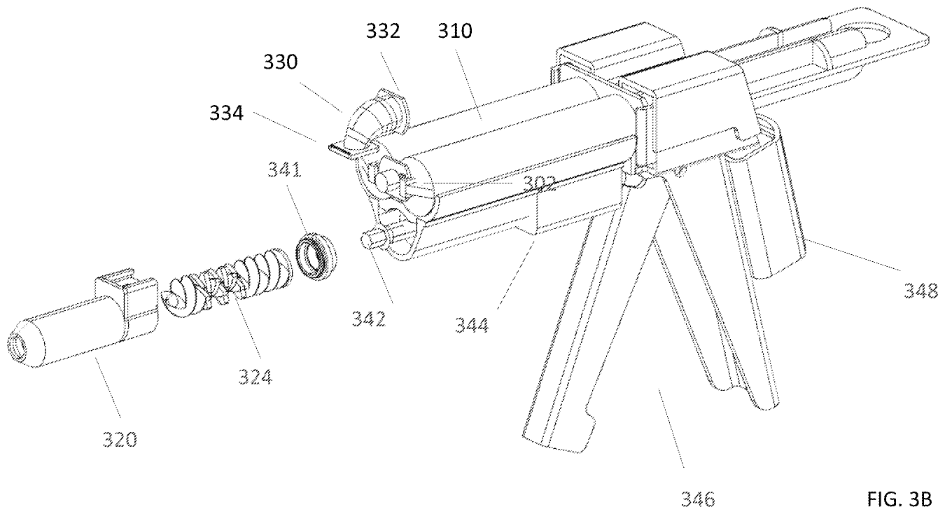

FIG. 3A is a side perspective view of a mixing device 300, according to one embodiment. FIG. 3B is an exploded view of the mixing device 300 of FIG. 3A. The adaptor 330 connects, via a collar lock 302, to the fluid delivery component 310 (including multiple cartridges to provide feeding materials) at the first end 332 and connects to the mixer tip 320 at the second end 334. Multiple feeding material can be dispensed, via operating a manual dispenser 346, from the respective cartridges of the fluid delivery component 310 into the adaptor 330, and from the adaptor 330 into the mixer tip 320. The mixer tip 320 has a mixing chamber receiving a mixing element 324 which is connected to a shaft 342 and rotated by running a motor 344 powered by a battery 348. A mechanical seal 341 is provided to seal the end of the mixing chamber from which the shaft 342 extends out.

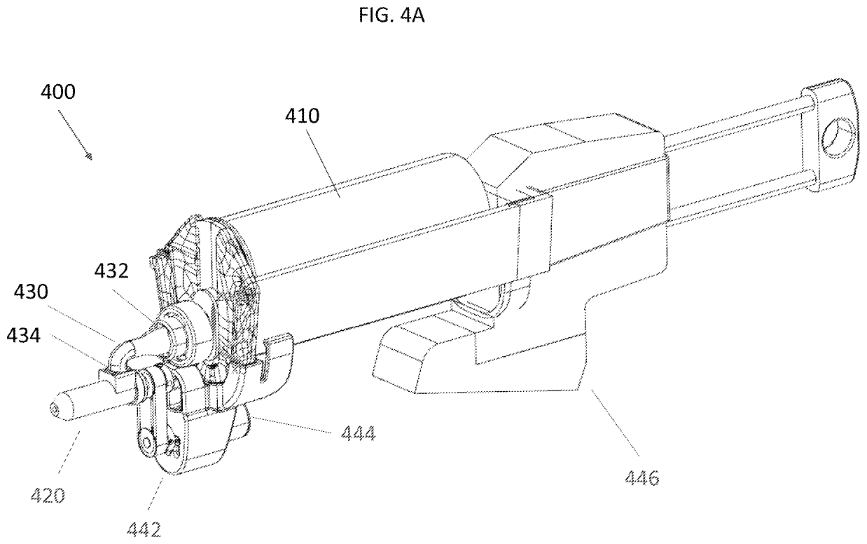

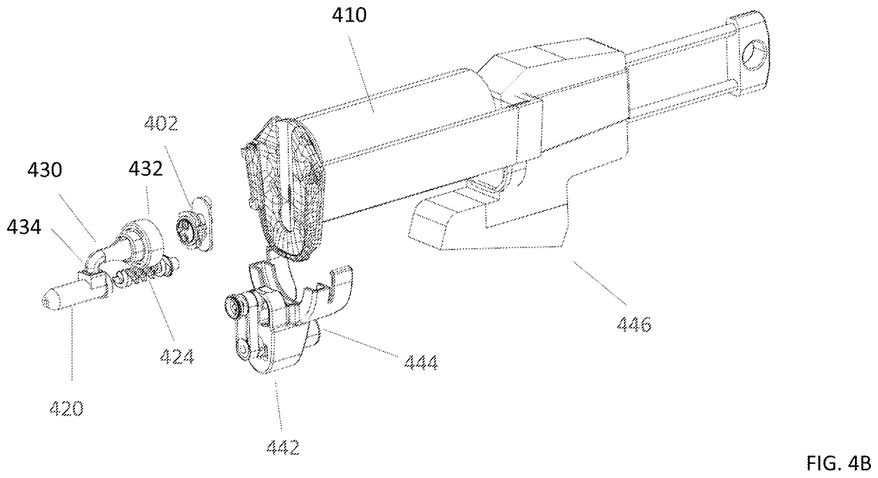

FIG. 4A is a side perspective view of a mixing device 400, according to one embodiment. FIG. 4B is an exploded view of the mixing device 400 of FIG. 4A. The mixing device 400 includes an adapter 430 connecting to a fluid delivery component 410 at one end and to a mixer tip 420 at another end. The adaptor 430 connects, via a collar lock 402, to the fluid delivery component 410 (including multiple cartridges to provide feeding materials) at the first end 432 and connects to the mixer tip 420 at the second end 434. Multiple feeding material can be dispensed, via operating a manual dispenser 446, from the respective cartridges of the fluid delivery component 410 into the adaptor 430, and from the adaptor 430 into the mixer tip 420. The mixer tip 420 has a mixing chamber receiving a mixing element 424 which is rotated by a belt and gear component 442 when operating a motor 444.

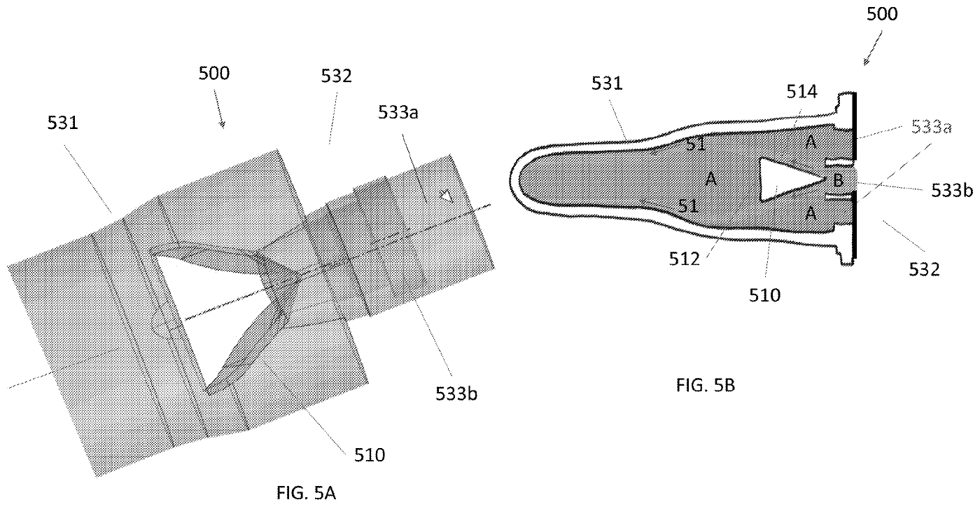

FIG. 5A is a side perspective view of a portion of an adapter 500, according to one embodiment. FIG. 5B is an illustration of feeding fluid materials A and B in the adapter 500 of FIG. 5A. FIG. 5C is a cross-sectional view of a simulated fluid concentration for fluid materials A and B in the adapter 500 of FIG. 5A, according to one example. The adapter 500 includes a conduit 531 extending between a first end 532 and a second end (not shown). Multiple inlets 533a and 533b are provided at the first end 532 of the conduit 531, configured to receive multiple fluid feeding materials from the respective cartridges of a fluid delivery component. In the depicted embodiment, the first inlet 533a substantially surrounds the second inlet 533b which is located at a central portion of the first end 532.

A diverter block 510 is provided inside the conduit 531 adjacent to the second inlet 533b. The diverter block 510 has a tapered shape which tapers away from a base 512 to form a sloped surface 514 facing to the fluid flow from the second inlet 533b. In the depicted embodiment of FIG. 5B, the diverter block 510 has a wedge shape. It is to be understood that the diverter block 510 can have various shapes including, for example, a cone, a pyramid, a prism, or any complicated three-dimensional (3D) geometry. Adding a diverter block at least in one of the inlets can redirect the material to improve the distribution within the conduit before it enters the mixing chamber. The diverter block splits the flow at the entrance of one of the plurality of inlets in such a way that the material is redistributed on the outside wall of the conduit by folding or sandwiching the combined material before reaching the outlet of the conduit. See arrows 51 in FIG. 5B indicating the fluid flow of material B downstream of the diverter block 510.

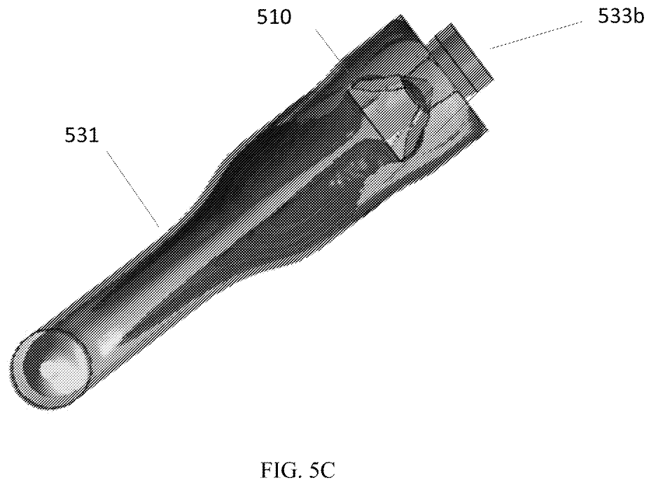

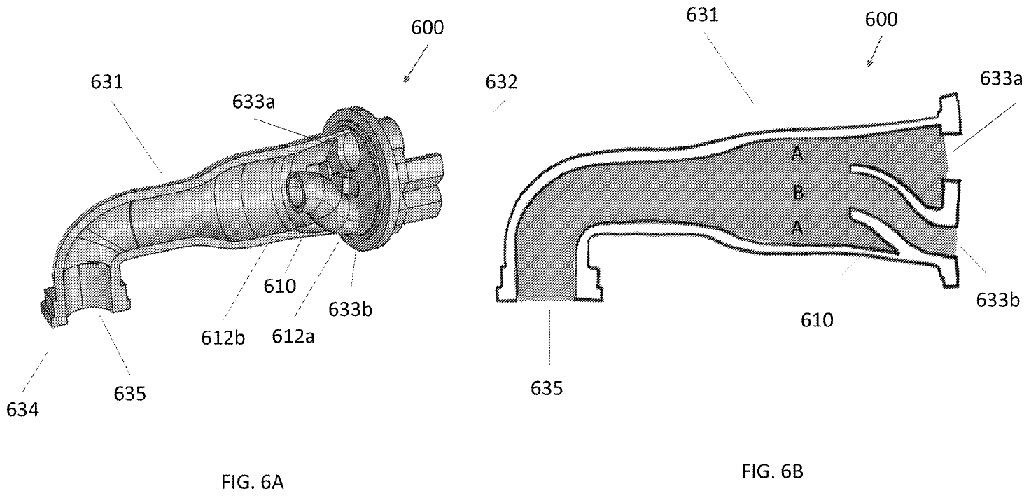

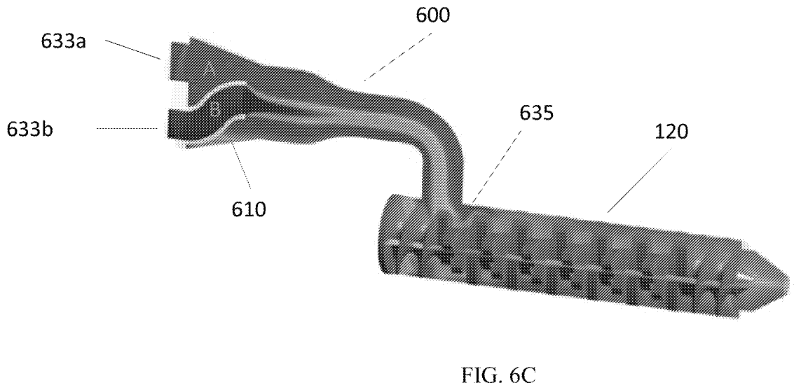

FIG. 6A is a side perspective view of an adapter 600, according to one embodiment. FIG. 6B is an illustration of fluids A and B in the adapter 600 of FIG. 6A. FIG. 6C is a cross-sectional view of a simulated fluid concentration for fluids A and B in the adapter of FIG. 6A, according to one example. The adapter 600 includes a conduit 631 extending between a first end 632 and a second end 634. Multiple inlets 633a and 633b are disposed at the first end 632 of the conduit 631, configured to receive multiple fluid feeding materials from the respective cartridges of a fluid delivery component.

An inner tube 610 is provided inside the conduit 631. The inner tube 610 is connected to at least one of the multiple inlets 633 at the first end 632 of the conduit 631. In the depicted embodiment of FIG. 6A, the inner tube 610 extends from the second inlet 633b into the inside of the conduit 631, having a first end 612a sealingly connected to the inlet 633b, and an open end 612b opposite the first end 612b and pointing to a center of the conduit 631. The inner tube 610 can be formed by extending the entrance wall of at least one of the inlets inside the conduit 631, forming a tube-in-tube structure. Such a structure can improve the material distribution in the conduit 631 before the materials enter a downstream mixing chamber of a mixer tip. The inner tube 610 connected to an inlet is positioned in such a way that the material from that inlet is distributed at the core or center of the conduit 631. For example, as shown in FIG. 6B, the inner tube 610 extends from the second inlet 633b. The material B from the second inlet 633b flows into the inner tube 610 and is directed by the inner tube 610 into the core or center of the conduit 631 such that the material B is wrapped around by the material A from the first inlet 633a before reaching the outlet 635 of the conduit 631.

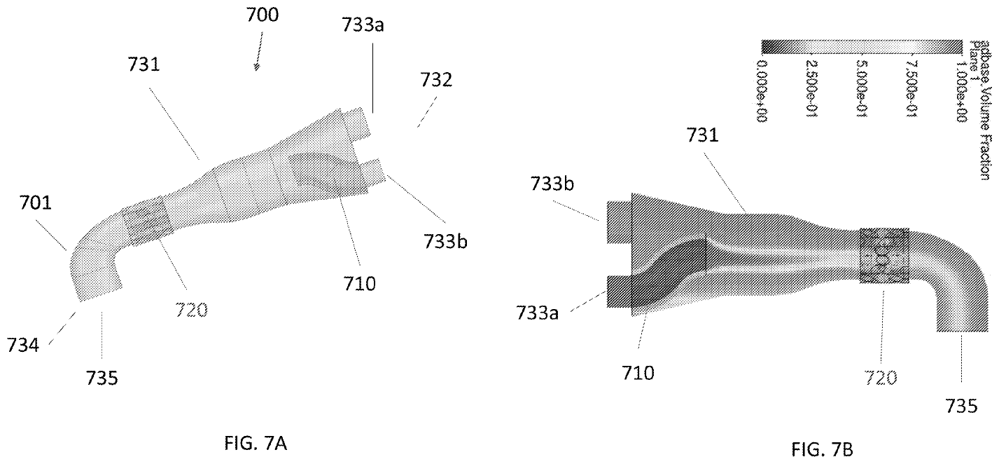

FIG. 7A is a side perspective view of an adapter 700, according to one embodiment. FIG. 7B is a cross-sectional view of a simulated fluid concentration for fluids A and B in the adapter 700 of FIG. 7A, according to one example. The adapter 700 includes a conduit 731 extending between a first end 732 and a second end 734. Multiple inlets 733a and 733b are disposed at the first end 732 of the conduit 731, configured to receive multiple fluid feeding materials from the respective cartridges of a fluid delivery component. An inner tube 710 is provided inside the conduit 731, connecting to the second inlets 733b. The inner tube 710 may have similar structures as the inner tube 610 of FIG. 6A.

The conduit 731 has an L-shaped portion with a turning point 701 thereof adjacent to the outlet 735. The conduit 731 further includes a tortuous path 720 formed on the inner wall of the conduit 731 adjacent to the turning point of the L-shaped portion. The tortuous path 720 can have holes, poles or forked type of structures that can be nested into each other by merging the structures at an angle and breaking the path of the conduit into several small flow paths to enhance the mixing of the solutions. The cross-sectional geometry of the forked type structure can be cylindrical or have square edges that can be smaller than the size of a strand of hair (e.g., 50 micrometers or less) or as thick as a needle size (e.g., 1000 micrometers or more). Such structures can provide an obstacle or maze to the direction of the flow. In another configuration the tortuous path 720 can have a twist produced by helices or spiral configurations to break the solution even more. The tortuous path 720 helps to redistribute the materials by homogenizing the material before exiting the outlet 735 and entering a high rate mixing chamber.

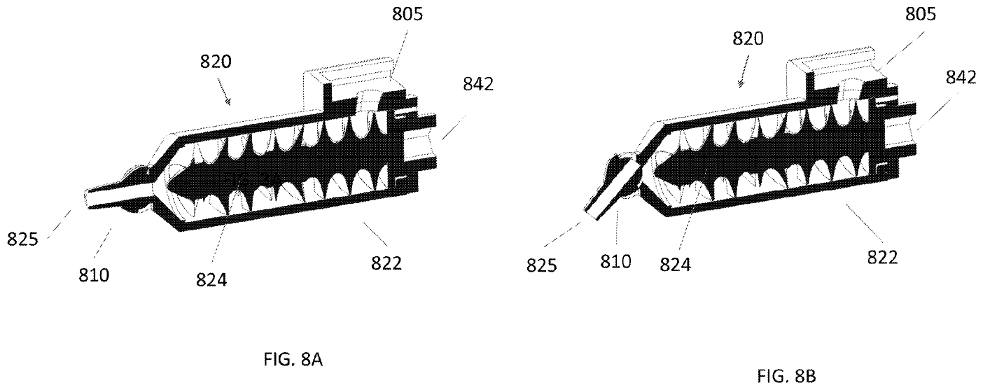

A ball shut off tip valve can be provided at an outlet of the mixing chamber that open or closes to allow for mixing inside the chamber before exiting the chamber. FIG. 8A is a cross-sectional view of a mixer tip 820 in an open state, according to one embodiment. FIG. 8B is a cross-sectional view of the mixer tip 820 of FIG. 8A in a closed state, according to one embodiment. The mixer tip 820 is configured to receive the multiple feeding materials from an adapter described herein, substantially mix the multiple feeding materials inside a mixing chamber 822 to form a mixture, and deliver the mixture via an outlet 825. A mixing element 824 is received in the mixing chamber 822. The mixing element 824 has a shaft 842 coupled with a motor to rotate the mixing element 824. A sliding mechanism 805 is provided to couple to a mounting mechanism of the adapter. A ball shut off tip valve 810 is provided at an outlet of the mixing chamber that open or closes to allow for mixing inside the chamber before exiting the chamber. The valve 810 can rotate inside of the end tip of the mixer 820 and it can move such as the flow path of the valve 810 can align (open valve) with the path of the flow in the mixer 820 or can be blocked (closed) by the rotation of the valve 810 keeping the material inside of the chamber of the mixer 820 and enhancing the mixing.

In some embodiments, a mixing device described herein can be a dynamic mixer, where a rotating element received in a mixing chamber of a mixing tip can be connected to a shaft attached to a motor to control the speeds of the rotating element. In some embodiments, a mixing device described herein can be a static mixer. One such advantage of exemplary embodiments of the present disclosure is that modular structures are provided to adapt to a delivery unit which allows a user to change a static delivery system to a rotating mixing system. The fluid exiting the outlet of an adapter feeds into a rotating unit including a rotating mixing element and decouples the fluid flow rate from the delivery unit to the rotating unit. Decoupling the fluid flow rate may refer to the ability to run the rotating mixing element at different angular speeds that respond to the properties of the mixing fluids like viscosity and level of mixing required. For example, the rotating unit in FIG. 6C can move at lower speeds for low viscosity fluids and high speed for high viscosity fluids. In another application the rotating unit in FIG. 8A can rotate at faster angular speeds to remove the mixing fluid faster or can rotate at a lower speed in FIG. 8B to provide additional mixing inside the chamber before exiting the mixing unit. In the case that the end of a mixing unit is connected to a mixing detection system, this device can provide some feedback to the motor unit and speed up or slow down the rotating unit to achieve the mixing required in real time.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### LISTING OF EXEMPLARY EMBODIMENTS

Exemplary embodiments are listed below. It is to be understood that any one of embodiments 1-8, 9-13, and 14-18 can be combined.

Embodiment 1 is an adapter for a mixing device comprising:
a conduit having a first end and a second end;
a plurality of inlets disposed at the first end of the conduit, configured to receive a plurality of fluid feeding materials;
an outlet disposed at a second end of the conduit fluidly connected to the plurality of inlets,
wherein the conduit, the plurality of inlets, and the outlet are configured such that the plurality of fluid feeding materials are not substantially mixed with each other when exiting from the outlet.

Embodiment 2 is the adapter of embodiment 1, further comprising a diverter block disposed inside the conduit adjacent to at least one of the plurality of inlets, configured to split a fluid flow from the at least one inlet.

Embodiment 3 is the adapter of embodiment 1 or 2, further comprising an inner tube disposed inside the conduit, the inner tube including a first end connected to at least one of the plurality of inlets, and a second end opposite the first end and pointing to a center of the conduit.

Embodiment 4 is the adapter of any one of embodiments 1-3, wherein the conduit further comprises a particle inlet configured to receive a particle feeding material.

Embodiment 5 is the adapter of any one of embodiments 1-4, wherein the conduit has a tapered shape which tapers away from the first end to the second end.

Embodiment 6 is the adapter of any one of embodiments 1-5, wherein the conduit has an L shape portion at the second end with a turning point adjacent to the outlet.

Embodiment 7 is the adapter of embodiment 6, wherein the conduit further comprises a tortuous path upstream of the turning point of the L shape.

Embodiment 8 is the adapter of any one of embodiments 1-7, further comprising a mounting mechanism at the first or second end.

Embodiment 9 is a mixing device comprising:
a fluid delivery component configured to provide a plurality of fluid feeding materials:
a mixer tip configured to mix the plurality of fluid feeding materials; and
the adapter of any one of embodiments 1-8, the conduit of the adapter connected to the fluid delivery component at the first end and connected to the mixer tip at the second end.

Embodiment 10 is the mixing device of embodiment 9, wherein the mixer tip comprises a mixing chamber and a mixing element received in the mixing chamber.

Embodiment 11 is the mixing device of embodiment 9 or 10, which is a dynamic mixer, wherein the mixer tip comprises a rotating element.

Embodiment 12 is the mixing device of any one of embodiments 9-11, wherein the mixer tip includes a ball shut off tip valve at a mixer outlet thereof, the valve opens or closes to allow for mixing inside the mixer tip before exiting the mixer outlet.

Embodiment 13 is the mixing device of any one of embodiments 9-12, wherein the fluid delivery component comprises a first cartridge receiving a first fluid material and a second cartridge receiving a second fluid material, the first and second fluid materials having a ratio of viscosity in a range from 10:1 or 500:1, and the first and second cartridges being configured to deliver the first and second fluid materials in a flow rate in a range from 10 mL/min to 1000 mL/min.

Embodiment 14 is a method comprising:
delivering a plurality of fluid feeding materials from a fluid delivery component to a plurality of inlets of an adapter; and
transferring the plurality of fluid feeding materials from the plurality of inlets to an outlet of the adapter such that the plurality of fluid feeding materials are not substantially mixed with each other when exiting from the outlet.

Embodiment 15 is the method of embodiment 14, further comprising delivering the plurality of fluid feeding materials from the outlet of the adapter to a mixer tip.

Embodiment 16 is the method of embodiment 15, further comprising mixing the plurality of fluid feeding materials in the mixer tip to form a mixture.

Embodiment 17 is the method of embodiment 16, further comprising controlling a delivery of the mixture from a mixer outlet of the mixer tip via a shut off valve.

Embodiment 18 is the method of embodiment 16 or 17, further comprising controlling a mixing speed to control a delivery of the mixture from a mixer outlet of the mixer tip.

### EXAMPLES

These examples are merely for illustrative purposes and are not meant to be limiting on the scope of the appended claims.

### Example 1. Adapter Including a Diverter Block

An adapter having the configuration of the adapter 500 shown in FIG. 5A was used to simulate fluid flow of materials A and B through the adapter via a computational fluid dynamics (CFD) simulation model. The geometry of the mixer was created via a CAD file. The CAD file was input to the CFD model for simulation of flowing fluid A and fluid B. Fluid A is 3M Scotch-Weld low odor acrylic adhesive accelerator part (reference DP 8810NS Green) with a viscosity of 35000 cP and density of 1.08 g/cc. Fluid B is 3M Scotch-Weld low odor acrylic adhesive base part (reference DP8810NS Green) with a viscosity of 90000 cP and density of 1.08 g/cc. The mix ratio by volume and weight is 10 part Fluid A: 1 part Fluid B.

FIG. 5C illustrates a cross sectional view of the simulated fluid concentration for fluid A and fluid B in the digital 3D model of the adapter. It was found that the diverter block can redistribute the lower viscosity (Material B) surrounding the high viscosity (Material A) before they enter the tapering section of the adapter and forcing the materials to combine or fuse with each other at the lower cross-sectional area.

### Example 2. Adapter Including an Inner Tube

An adapter having the configuration of the adapter 600 shown in FIG. 6A was used to simulate fluid flow of materials A and B through the adapter connected to a mixer tip 120 of FIG. 1 via a computational fluid dynamics (CFD) simulation model. The geometry of the mixing device was created via a CAD file. The CAD file was input to the CFD model for simulation of flowing fluid A and fluid B. Fluid A is 3M Scotch-Weld low odor acrylic adhesive accelerator part (reference DP 8810NS Green) with a viscosity of 35000 cP and density of 1.08 g/cc. Fluid B is 3M Scotch-Weld low odor acrylic adhesive base part (reference DP8810NS Green) with a viscosity of 90000 cP and density of 1.08 g/cc. The mix ratio by volume and weight is 10 part Fluid A: 1 part Fluid B.

FIG. 6C illustrates a cross sectional view of the simulated fluid concentration for fluid A and fluid B in the digital 3D model of the mixing device. The high viscosity (material A) is added in the cavity and mix with the lower viscosity (material B) and transported into the dynamic mixing chamber. It was found in FIG. 6C that an appropriate mixing was obtained at the mixer tip for a given speed of the dynamic mixer.

### Example 3. Adapter Including a Tortuous Path

An adapter having the configuration of the adapter 500 shown in FIG. 5A was used to simulate fluid flow of materials A and B through the adapter via a computational fluid dynamics (CFD) simulation model. The geometry of the mixer was created via a CAD file. The CAD file was input to the CFD model for simulation of flowing fluid A and fluid B. Fluid A is 3M Scotch-Weld low odor acrylic adhesive accelerator part (reference DP 8810NS Green) with a viscosity of 35000 cP and density of 1.08 g/cc. Fluid B is 3M Scotch-Weld low odor acrylic adhesive base part (reference DP8810NS Green) with a viscosity of 90000 cP and density of 1.08 g/cc. The mix ratio by volume and weight is 10 part Fluid A: 1 part Fluid B. FIG. 7B illustrates a cross sectional view of the simulated fluid concentration for fluid A and fluid B in the digital 3D model of the adapter. It was found that the tortuous path provides additional premix of the two materials before they enter the high rate mixing system.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments. While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, various exemplary embodiments have been described. These and other embodiments are within the scope of the following claims.

1. An adapter for a mixing device comprising:
a conduit having a first end and a second end;
a plurality of inlets disposed at the first end of the conduit, configured to receive a plurality of fluid feeding materials;
an outlet disposed at a second end of the conduit fluidly connected to the plurality of inlets;
a diverter block disposed inside the conduit adjacent to at least one of the plurality of inlets, configured to split a fluid flow from the at least one inlet; and
an inner tube disposed inside the conduit, the inner tube including a first end connected to at least one of the plurality of inlets, and a second end opposite the first end and pointing to a center of the conduit,
wherein the conduit, the plurality of inlets, and the outlet are configured such that the plurality of fluid feeding materials are not substantially mixed with each other when exiting from the outlet.

2-3. (canceled)

4. The adapter of claim 1, wherein the conduit further comprises a particle inlet configured to receive a particle feeding material.

5. The adapter of claim 1, wherein the conduit has a tapered shape which tapers away from the first end to the second end.

6. The adapter of claim 1, wherein the conduit has an L shape portion at the second end with a turning point adjacent to the outlet.

7. The adapter of claim 6, wherein the conduit further comprises a tortuous path upstream of the turning point of the L shape.

8. The adapter of claim 1, further comprising a mounting mechanism at the first or second end.

9. A mixing device comprising:
a fluid delivery component configured to provide a plurality of fluid feeding materials;
a mixer tip configured to mix the plurality of fluid feeding materials; and
an adapter comprising:
a conduit having a first end and a second end, the conduit being connected to the fluid delivery component at the first end and connected to the mixer tip at the second end;
a plurality of inlets disposed at the first end of the conduit, configured to receive a plurality of fluid feeding materials;
an outlet disposed at a second end of the conduit fluidly connected to the plurality of inlets;
a diverter block disposed inside the conduit adjacent to at least one of the plurality of inlets, configured to split a fluid flow from the at least one inlet; and
an inner tube disposed inside the conduit, the inner tube including a first end connected to at least one of the plurality of inlets, and a second end opposite the first end and pointing to a center of the conduit,
wherein the conduit, the plurality of inlets, and the outlet are configured such that the plurality of fluid feeding materials are not substantially mixed with each other when exiting from the outlet.

10. The mixing device of claim 9, wherein the mixer tip comprises a mixing chamber and a mixing element received in the mixing chamber.

11. The mixing device of claim 9, which is a dynamic mixer, wherein the mixer tip comprises a rotating element.

12. The mixing device of claim 9, wherein the mixer tip includes a ball shut off tip valve at a mixer outlet thereof, the valve opens or closes to allow for mixing inside the mixer tip before exiting the mixer outlet.

13. The mixing device of claim 9, wherein the fluid delivery component comprises a first cartridge receiving a first fluid material and a second cartridge receiving a second fluid material, the first and second fluid materials having a ratio of viscosity in a range from 10:1 or 500:1, and the first and second cartridges being configured to deliver the first and second fluid materials in a flow rate in a range from 10 mL/min to 1000 mL/min.

14. A method comprising:
delivering a plurality of fluid feeding materials from a fluid delivery component to a plurality of inlets of an adapter; and
transferring the plurality of fluid feeding materials from the plurality of inlets to an outlet of the adapter such that the plurality of fluid feeding materials are not substantially mixed with each other when exiting from the outlet.

15. The method of claim 14, further comprising delivering the plurality of fluid feeding materials from the outlet of the adapter to a mixer tip.

16. The method of claim 15, further comprising mixing the plurality of fluid feeding materials in the mixer tip to form a mixture.

17. The method of claim 16, further comprising controlling a delivery of the mixture from a mixer outlet of the mixer tip via a shut off valve.

18. The method of claim 16, further comprising controlling a mixing speed to control a delivery of the mixture from a mixer outlet of the mixer tip.
